(19) United States
(12) Patent Application Publication
(10) Pub. No.: US 2016/0156027 A1
(43) Pub. Date: Jun. 2, 2016

(54) POSITIVE ELECTRODE, LITHIUM BATTERY INCLUDING THE SAME, AND METHOD OF MANUFACTURING THE POSITIVE ELECTRODE

(71) Applicant: Samsung SDI Co., Ltd., Yongin-si (KR)

(72) Inventors: Jeonghoon Kim, Yongin-si (KR); Yumi Song, Yongin-si (KR); Mingzi Hong, Yongin-si (KR); Dohyung Park, Yongin-si (KR)

(21) Appl. No.: 14/730,114

(22) Filed: Jun. 3, 2015

(30) Foreign Application Priority Data
Nov. 27, 2014 (KR) 10-2014-0167809

(51) Int. Cl. H01M 4/36; H01M 10/0587; H01M 10/0525; H01M 4/525; H01M 4/505

(52) U.S. Cl. CPC H01M 4/366; H01M 4/525; H01M 4/505; H01M 10/0525; H01M 10/0587; H01M 2004/028

(57) ABSTRACT

A positive electrode includes a current collector, and a positive active material layer on at least one surface of the current collector and including a positive active material. The positive active material layer includes a first portion adjacent to the current collector, and a second portion adjacent to an outer surface of the positive active material layer. Since the second portion includes a metal component, structural stability of the positive electrode may be improved. Accordingly, lifespan characteristics of a lithium battery including the positive electrode may be improved.

### CROSS-REFERENCE TO RELATED APPLICATION

This application claims priority to and the benefit of Korean Patent Application No. 10-2014-0167809, filed on Nov. 27, 2014, in the Korean Intellectual Property Office, the disclosure of which is incorporated herein in its entirety by reference.

### BACKGROUND

1. Field

One or more aspects of embodiments of the present invention relate to positive electrodes, lithium batteries including the same, and methods of manufacturing the positive electrodes.

2. Description of the Related Art

The development of compact and advanced electronic devices, such as digital cameras, mobile devices, laptops, and personal computers has increased the demand for lithium secondary batteries as an energy source. Also, with the spread of hybrid electric vehicles (HEVs), plug-in hybrid electric vehicles (PHEVs), and electric vehicles (EVs), the development of high-capacity and safe lithium secondary batteries is in progress.

To aid in the development of lithium batteries, research on various positive active materials has been conducted.

Although a single-component lithium cobalt oxide (LiCoO₂) has been used in the related art as a positive active material of lithium batteries, use of high-capacity lithium metal composite oxide having a layered structure of (Li(Ni—Co—Mn)O₂ and Li(Ni—Co—Al)O₂) has been increasing in recent years. In addition, spinel-type lithium manganese oxides (LiMn₂O₄) and olivine-type (or olivine structure) lithium iron phosphate oxides (LiFePO₄) have been researched.

However, there is still a need to develop methods of reducing side reactions between the lithium metal composite oxide and an electrolytic solution and improving lifespan characteristics of a lithium battery after repeated charging and discharging.

### SUMMARY

One or more aspects of embodiments of the present invention are directed to positive electrodes including a current collector and a positive active material layer on at least one surface of the current collector, the positive active material layer including a first portion adjacent to the current collector, and a second portion adjacent to an outer surface of the positive active material layer and including a metal component. The positive electrodes according to embodiments of the present invention may have reduced reactivity with an electrolytic solution and high stability.

One or more embodiments are directed to lithium batteries including the positive electrodes and having excellent lifespan characteristics.

One or more embodiments are directed to methods of manufacturing the positive electrodes.

Additional aspects will be set forth in part in the description which follows and, in part, will be apparent from the description, or may be learned by practice of the presented embodiments.

According to one or more embodiments, a positive electrode for a lithium battery includes: a current collector; and a positive active material layer on at least one surface of the current collector and including a positive active material, where the positive active material layer includes a first portion adjacent to the current collector, and a second portion adjacent to an outer surface of the positive active material layer and including a metal component.

The first portion may include a first positive active material, and the second portion may include a second positive active material having a coating layer including the metal component.

A thickness of the positive active material layer may be in a range of about 1 μm to about 50 μm.

The second portion may be about 5% to about 70% of a total thickness of the positive active material layer, the second portion extending inward from the outer surface of the positive active material layer.

The coating layer may be a discontinuous island-type (or island-shaped) coating layer.

The metal component may include at least one element selected from magnesium (Mg), aluminum (Al), silicon (Si), tin (Sn), nickel (Ni), calcium (Ca), zinc (Zn), cobalt (Co), titanium (Ti), zirconium (Zr), yttrium (Y), manganese (Mn), and vanadium (V).

The metal component may be in at least one state selected from a metal state, a metal oxide state, and a lithium metal oxide state.

The metal component may include at least one selected from Zr, ZrO₂, and Li₂ZrO₃.

An amount of the metal component may be in a range of about 0.05 mol to about 0.8 mol based on 1 mol of the positive active material.

The second positive active material may further include a diffusion layer extending from the coating layer inward toward the center of the second positive active material.

A thickness of the diffusion layer may be in a range of about 1 nm to about 500 nm.

The first positive active material and the second positive active material may each independently include a lithium metal composite oxide having a layered structure.

The lithium metal composite oxide may be lithium nickel composite oxide represented by Formula 1 below:

Liₐ(NiₓCo_{y}Mn_{z})O₂. Formula 1

In Formula 1, 0.8<a≦1.2, 0.6≦x≦1, 0≦y≦0.4, 0≦z≦0.4, and x+y+z≦1.2, and Co and Mn may be each independently substituted with at least one element selected from Ca, Mg, Al, Ti, Sr, Fe, Ni, Cu, Zn, Y, Zr, Nb, and B.

The first positive active material and the second positive active material may include the same lithium metal composite oxide.

The diffusion layer may include a lithium metal oxide.

According to one or more embodiments, a lithium battery includes the positive electrode.

According to one or more embodiments, a method of manufacturing a positive electrode for a lithium battery includes: forming a first portion of a positive active material layer by coating a first positive active material composition on at least one surface of a current collector; and forming a second portion of the positive active material layer by coating a second positive active material composition including a metal component on the first portion.

Thickness of the second portion may be about 5% to about 70% of a total thickness of the positive active material layer, the second portion extending inward from an outer surface of the positive active material layer.

The second positive active material composition comprising the metal component may be prepared by preparing a core of a second positive active material and coating the core with a coating solution comprising the metal component, and the coating solution may include about 0.05 parts by weight to about 5 parts by weight of the metal component based on 100 parts by weight of the core of the second positive active material.

The forming of the first portion of the positive active material layer may further include drying the first portion of the positive active material layer after the forming of the first portion of the positive active material layer.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic diagram of a structure of a positive electrode according to one or more embodiments;

FIG. 2 is a schematic diagram of a structure of a second positive active material according to one or more embodiments;

FIG. 3 is a schematic diagram of a structure of a second positive active material according to one or more embodiments;

FIG. 4 is a schematic diagram of a structure of a second positive active material according to one or more embodiments;

FIG. 5 is a schematic diagram of a cross-sectional structure of a comparative positive electrode;

FIG. 6 is a schematic diagram of a cross-sectional structure of a positive electrode according to one or more embodiments;

FIG. 7 is a schematic perspective diagram of a structure of a lithium battery according to one or more embodiments;

FIG. 8 is a scanning electron microscope (SEM) image of a surface of Li[Ni_{0.65}Co_{0.20}Mn_{0.15}]O₂ obtained with a magnification of 40,000×;

FIG. 9 is an SEM image of a surface of a positive active material prepared according to Preparation Example 1 obtained with a magnification of 40,000×;

FIG. 10 is a high resolution transmission electron microscope (HRTEM) image of the surface of the positive active material prepared according to Preparation Example 1 obtained with a magnification of 200,000× (left), and an enlarged HRTEM image of a portion of the surface thereof obtained with a magnification of 400,000× (right);

FIG. 11 is a scanning transmission electron microscope (STEM) image of the surface of the positive active material prepared according to Preparation Example 1 obtained with a magnification of 100,000×;

FIG. 12 illustrates an enlarged image of a portion of the STEM image of FIG. 11 (top), a fast Fourier transform (FFT) analysis image of one point of a diffusion layer (bottom left), and an FFT analysis image of one point of Li[Ni_{0.65}Co_{0.20}Mn_{0.15}]O₂ (bottom right);

FIG. 13 is X-ray diffraction (XRD) analysis results of positive active materials prepared according to Preparation Examples 1 and 2;

FIG. 14 is an SEM image of a cross-section of a positive active material layer prepared according to Example 1 obtained with a magnification of 2,500×;

FIG. 15 is an SEM image of a first portion of a positive active material layer prepared according to Example 1 obtained with a magnification of 40,000×;

FIG. 16 is an SEM image of a second portion of the positive active material layer prepared according to Example 1 obtained with a magnification of 40,000×;

FIG. 17 is a graph of energy dispersive X-ray analysis (EDX) results of one point of the first portion of the positive active material layer prepared according to Example 1; and

FIG. 18 is a graph of EDX results of one point of the second portion of the positive active material layer prepared according to Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of” when preceding a list of elements, modify the entire list of elements and do not modify the individual elements of the list. Further, the use of “may” when describing embodiments of the present invention refers to “one or more embodiments of the present invention.” In addition, as used herein, the terms “use,” “using,” and “used” may be considered synonymous with the terms “utilize,” “utilizing,” and “utilized,” respectively.

As used herein, the term “substantially,” “about,” and similar terms are used as terms of approximation and not as terms of degree, and are intended to account for the inherent deviations in measured or calculated values that would be recognized by those of ordinary skill in the art.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §1 12, first paragraph, and 35 U.S.C. §132(a).

In a comparative lithium battery, when the lithium metal composite oxide having a layered structure is used, lithium ions are deintercalated during charging due to repeated charging and discharging, and thus the layered structure may be destroyed.

In addition, when a lithium metal composite oxide including cobalt is used, deintercalation of lithium ions during charging may facilitate oxidation of trivalent cobalt ions into tetravalent cobalt ions, which are easily involved in side reactions with an electrolytic solution. Accordingly, as cobalt ions are dissolved in the electrolytic solution, the structure of the lithium metal composite oxide is further destroyed.

Also, when an amount of nickel contained in a lithium metal composite oxide is increased to improve capacity and rate property, an amount of Ni²⁺ ions capable of substituting lithium increases, thereby generating nickel(II) oxide (NiO), which may serve as an impurity. The generated NiO having high reactivity is easily involved in reactions with an electrolyte, thereby reducing structural stability of the lithium metal composite oxide. Furthermore, as partial pressure of oxygen increases due to decomposition of the oxide, side reactions with the electrolytic solution further increase, thereby exacerbating the structural deformation.

Once the structural deformation occurs, lithium ions cannot be intercalated during discharging, and thus discharge capacity of the battery decreases and lifespan characteristics may be deteriorated.

For the purpose of inhibiting structural deformation of a positive active material and side reactions with an electrolytic solution generally caused by repeated charging and discharging, various methods of reforming the surface of the positive active material have been used. For example, a method of forming a coating layer on the surface of the positive active material may be used for the surface reformation. However, when the method of forming a coating layer on the surface of the positive active material is used, surface resistance of the positive active material increases with an increase of a thickness of the coating layer or according to components of the coating layer. Thus, although lifespan characteristics of a battery may be improved, capacity of the battery may be reduced.

Embodiments of the present invention are directed to a method of improving lifespan characteristics while inhibiting capacity reduction by reforming only the surface of some portions of positive active material which are highly reactive with the electrolytic solution in the positive electrode.

Particularly, a positive electrode for a lithium battery according to one or more embodiments includes: a current collector; and a positive active material layer on at least one surface of the current collector and including a positive active material. The positive active material layer includes a first portion adjacent to the current collector and a second portion adjacent to an outer surface of the positive active material layer, the second portion including a metal component.

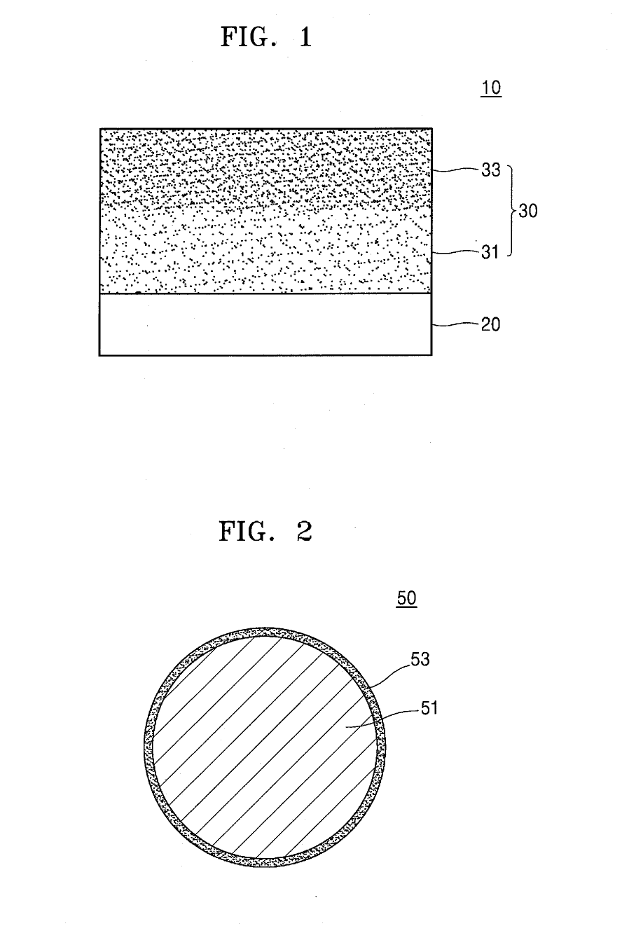

FIG. 1 illustrates a schematic structure of a positive electrode according to one or more embodiments. As illustrated in FIG. 1, a positive active material layer 30 is positioned on at least one surface of a current collector 20, and includes a first portion 31 adjacent to the current collector 20 and a second portion 33 on the first portion 31 and adjacent to an outer surface of the positive active material layer 30. The second portion 33 includes a metal component.

As used herein, the term “metal component” refers to a metal component not contributing to a main crystal structure of the positive active material. Particularly, it refers to any metal or metal-containing component, which is not used to form the main crystal structure of the positive active material. For example, a crystal structure of compounds used as the positive active material generally is a layered structure, an olivine structure, or a spinel structure that allows for intercalation and deintercalation of lithium ions, and the elements involved in the formation of the crystal structure constitute a regular geometric alignment within the crystal. In contrast, the “metal component” used herein is different from the elements constituting the crystal structure.

According to one or more embodiments, the metal component may include at least one element selected from magnesium (Mg), aluminum (Al), silicon (Si), tin (Sn), nickel (Ni), calcium (Ca), zinc (Zn), cobalt (Co), titanium (Ti), zirconium (Zr), yttrium (Y), manganese (Mn), and vanadium (V).

These elements may be in at least one state of metal, metal oxide, and lithium metal oxide.

The metal may be a neutral metal atom or a positively charged metal ion. The metal oxide may be a compound in which oxygen is combined with the metal. The lithium metal oxide may be a compound in which both lithium and metal bind to oxygen or a compound in which an anion containing the metal and oxygen binds to a lithium cation.

For example, the metal oxide may include at least one selected from MgO, Al₂O₃, SiO₂, SnO₂, NiO, ZnO, TiO₂, ZrO₂, Y₂O₃, MnO, V₂O₃, and V₂O₅.

For example, the lithium metal oxide may include at least one selected from LiZnO₂, Li₂ZrO₃, and LiVO₂.

According to one or more embodiments, the metal component may include at least one selected from Zr, ZrO₂, and Li₂ZrO₃.

An amount of the metal component may be in a range of about 0.05 mol to about 0.8 mol based on 1 mol of the positive active material. When the amount of the metal component is within the range described above, the structural deformation on the surface of the positive active material may be prevented (or sufficiently reduced) and reduction in capacity of the positive active material may be inhibited (or substantially inhibited). Thus, structural stability may be improved while maintaining capacity at a desired level or at a level greater than the desired level.

According to one or more embodiments, the first portion of the positive active material layer may include a first positive active material, and the second portion of the positive active material layer may include a second positive active material having a coating layer including the metal component.

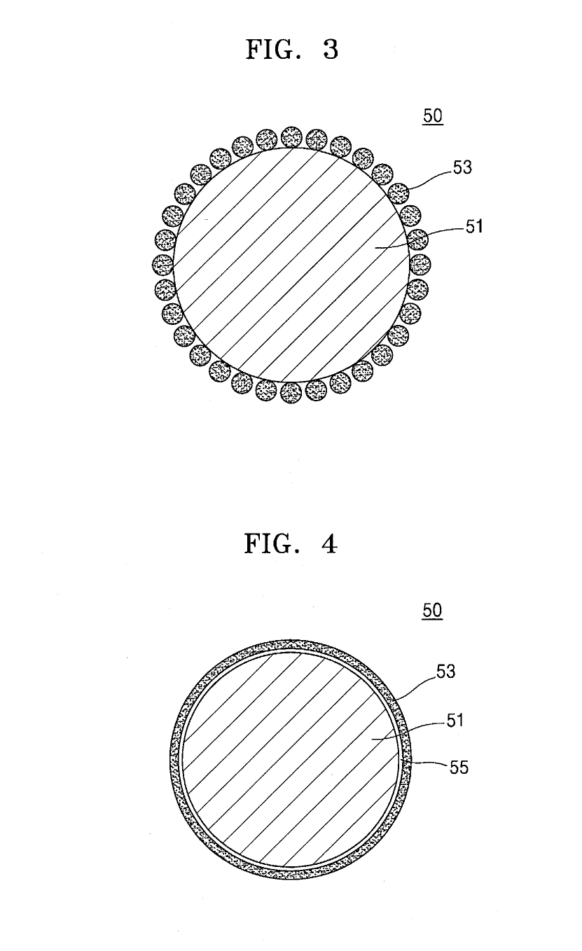

FIGS. 2 and 3 each illustrate a schematic structure of the second positive active material according to one or more embodiments. As illustrated in FIGS. 2 and 3, the second positive active material 50 may have a coating layer 53 including the metal component, and the coating layer 53 may be formed on a core 51.

Referring to FIG. 2, the coating layer 53 may be a continuous coating layer. Herein, “a continuous coating layer” refers to a coating layer formed on the entire surface of a core.

Referring to FIG. 3, the coating layer 53 may be a discontinuous island-type (or island-shaped) coating layer. Herein, the term “island-type” or “island-shaped” refers to a spherical, semi-spherical, non-spherical, or amorphous shape having a set or predetermined volume, without being limited thereto. The island-type coating layer 53 may be a discontinuous coating layer formed of spherical particles, as illustrated in FIG. 3, or a non-uniform coating layer including a plurality of particles each constituting a substantially constant volume.

The coating layer 53 may include the metal component as described above. In some embodiments, the metal component of the coating layer may be in a form of at least one of metal and metal oxide.

In the coating layer, the metal and/or the metal oxide are not involved in chemical reactions of the battery and may not react with the electrolytic solution. Thus, side reactions between the positive active material and the electrolytic solution due to electron transfer between the core of the positive active material and the electrolytic solution may be prevented or reduced by the coating layer including the metal component. In addition, the coating layer may be integrated with the core to prevent or reduce the occurrence of side reactions such as release of transition metal at a high temperature or gas generation at a high voltage. In some embodiments, during charging and discharging of the battery, the coating layer inhibits (or substantially inhibits) the structural deformation of the surface of the positive active material, thereby improving stability and lifespan characteristics of the lithium battery including the positive active material.

When the metal component includes zirconium and/or zirconium oxide ZrO₂, zirconium is not substituted for elements constituting the crystal structure of the second positive active material during the formation of the coating layer, and thus reduction of the discharge capacity of the battery may be prevented (or substantially inhibited). In addition, since ZrO₂ has low electric conductivity and is not involved in oxidation/reduction reactions in the battery, side reactions of the positive active material with the electrolytic solution may be reduced by the coating layer of the positive active material. Furthermore, since ZrO₂ has excellent thermal conductivity, heat generated in the positive electrode may be efficiently discharged to the outside, thereby inhibiting (or substantially inhibiting) exothermic reactions inside the battery.

The second positive active material may further include a diffusion layer extending from the coating layer (e.g., from the inner circumference of the coating layer) inward toward the center of the second positive active material.

FIG. 4 illustrates a schematic structure of a second positive active material according to one or more embodiments of the present invention. As illustrated in FIG. 4, the second positive active material 50 may include a coating layer 53 formed on the core 51 and including the metal component, and a diffusion layer 55 extending from the coating layer 53 inward toward the center of the second positive active material. Although not shown in FIG. 4, the diffusion layer may similarly extend from an island-type coating layer illustrated in FIG. 3, inward toward the center of the second positive active material of FIG. 3.

The diffusion layer 55 may be formed via infiltration of the metal component into the core 51 in a small amount while forming the coating layer 53 including the metal component on the core 51. The diffusion layer 55 may be positioned between the core 51 and the coating layer 53.

The diffusion layer 55 may include a lithium metal oxide as the metal component.

For example, the lithium metal oxide may be a product of a reaction between infiltrated metal and lithium present on the surface of or inside the core 51, when metal contained in the metal component of the coating layer 53 infiltrates into the surface of the core 51 in a small amount.

For example, the lithium metal oxide may be a product of a reaction between infiltrated zirconium and lithium present on the surface of or inside the core 51, when zirconium contained in the metal component of the coating layer 53 infiltrates into the surface of the core 51 in a small amount.

The lithium metal oxide contained in the diffusion layer may be present between atoms of a crystal lattice without contributing to the crystal structure of the core. In addition, since the lithium metal oxide is able to intercalate and deintercalate lithium ions, capacity of the battery may be increased.

A thickness of the diffusion layer may be in a range of about 1 nm to about 500 nm, for example, about 10 nm to about 500 nm. When the thickness of the diffusion layer is within any of the ranges described above, the diffusion layer may increase capacity of the battery and improve structural stability of the positive electrode.

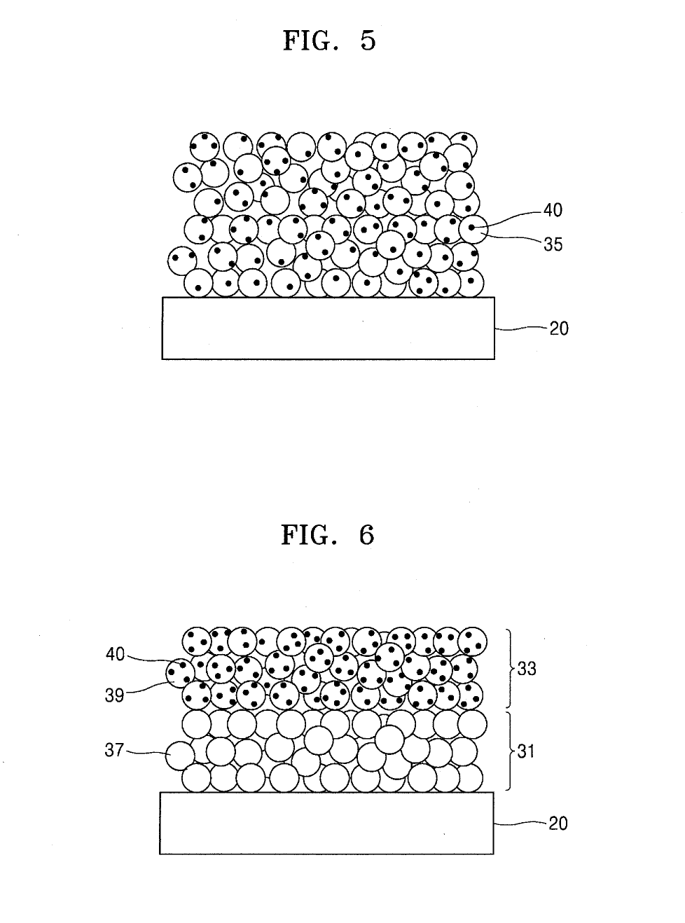

FIG. 5 illustrates a schematic cross-sectional structure of a comparative positive electrode. As illustrated in FIG. 5, the comparative positive electrode includes a positive active material layer formed on a current collector 20, and the positive active material layer includes a positive active material 35 and a coating layer 40 including the metal component, the coating layer 40 being distributed throughout the positive active material layer. Accordingly, the positive active material 35 positioned in the inner portion of the positive active material layer (which has a lower chance of contacting the electrolytic solution than the surface of the positive active material layer) also has the coating layer 40. As a result, the coating layer 40 may serve as a resistive layer, thereby reducing capacity of the battery.

FIG. 6 illustrates a schematic cross-sectional structure of a positive electrode according to one or more embodiments of the present invention. As illustrated in FIG. 6, the positive electrode includes a positive active material layer on a current collector 20, and the positive active material layer includes a first portion 31, which is adjacent to the current collector 20 and includes a first positive active material 37. The first positive active material 37 may not have a coating layer 40 including a metal component. In addition, the positive active material layer includes a second portion 33, which is formed on the first portion 31 and is adjacent to the outer surface of the positive active material layer. The second portion 33 may include a second positive active material 39, and the second positive active material 39 may have a coating layer 40 including a metal component. Thus, by disposing the coating layer only at a surface portion of the positive active material layer, the positive electrode according to one or more embodiments of the present invention may inhibit (or substantially inhibit) reduction in capacity of the battery and may block (or substantially block) the occurrence of side reactions between the positive active material and the electrolyte, while using substantially the same amount of coating layer as the comparative positive electrode.

When a positive electrode includes the metal component only at an upper (or surface) portion of the positive active material layer, as described in embodiments of the present invention, side reactions with the electrolyte and decrease in capacity may be inhibited (or substantially reduced). In contrast, when the first portion of the positive active material layer includes a positive active material having a coating layer, and the second portion includes a positive active material without a coating layer, the coating layer in the first portion may serve as a resistive layer but will not be able to substantially reduce side reactions of the positive active material with the electrolyte.

A thickness of the positive active material layer may be in a range of about 1 pin to about 50 μm. For example, the thickness of the positive active material layer 30 may be in a range of about 1 μm to about 10 μm, or about 3 μm to about 6 pin.

According to one or more embodiments, the second portion 33 of the positive active material layer may be within about 5% to about 70% of a total thickness of the positive active material layer and may extend inward from the outer surface of the positive active material layer. In some embodiments, the second portion 33 (extending inward from the outer surface of the positive active material layer) may be within about 10% to about 60%, for example, about 30% to about 60%, of the total thickness of the positive active material layer. When the thickness of the second portion 33 is within any of the ranges described above, structural stability of the positive electrode may be improved, and lifespan characteristics of the battery may be improved.

Any suitable positive active material commonly used and/or known in the art may be used as the positive active material. For example, the first positive active material and the second positive active material may each independently be selected from the group of compounds represented by: LiₐA_{1-b}B_{b}D₂ (where 0.90≦a≦1 and 0≦b≦0.5); LiₐE_{1-b}B_{b}O_{2-c}D_{c} (where 0.90≦a≦1, 0≦b≦0.5, and 0≦c≦0.05); LiE_{2-b}B_{b}O_{4-c}D_{c} (where 0≦b≦0.5 and 0≦c≦0.05); LiₐNi_{1-b-c}Co_{b}B_{c}Dₐ (where 0.90≦a≦1, 0≦b≦0.5, 0≦c≦0.05, and 0<α≦2); LiₐNi_{1-b-c}Co_{b}B_{c}O₂₋ₐFₐ (where 0.90≦a≦1, 0≦b≦0.5, 0≦c≦0.05, and 0<α<2); LiₐNi_{1-b-c}Co_{b}B_{c}O₂₋ₐF₂ (where 0.90≦a≦1, 0≦b≦0.5, 0≦c 0.05, and 0<α<2); LiₐNi_{1-b-c}Mn_{b}B_{c}Dₐ (where 0.90≦a≦1, 0≦b≦0.5, 0≦c≦0.05, and 0<α≦2); LiₐNi_{1-b-c}Mn_{b}B_{c}O₂₋ₐFₐ (where 0.90≦a≦1, 0≦b≦0.5, 0≦c≦0.05, and 0<α<2); LiₐNi_{1-b-c}Mn_{b}B_{c}O₂₋ₐF₂ (where 0.90≦a≦1, 0≦b≦0.5, 0≦c≦0.05, and 0<α<2); LiₐNi_{b}E_{c}G_{d}O₂ (where 0.90≦a≦1, 0≦b≦0.9, 0≦c≦0.5, and 0.001≦d≦0.1); LiₐNi_{b}Co_{c}Mn_{d}GₑO₂ (where 0.90≦a≦1, 0≦b≦0.9, 0≦c≦0.5, 0≦d≦0.5, and 0.001≦e≦0.1); LiₐNiG_{b}O₂ (where 0.90≦a≦1 and 0.001≦b≦0.1); LiₐCoG_{b}O₂ (where 0.90≦a≦1 and 0.001≦b≦0.1); LiₐMnG_{b}O₂ (where 0.90≦a≦1 and 0.001≦b≦0.1); LiₐMn₂G_{b}O₄ (where 0.90≦a≦1 and 0.001≦b≦0.1); QO₂; QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄.

In the formulae above, without being limited thereto, A is nickel (Ni), cobalt (Co), manganese (Mn), or any combination thereof; B is aluminum (Al), nickel (Ni), cobalt (Co), manganese (Mn), chromium (Cr), iron (Fe), magnesium (Mg), strontium (Sr), vanadium (V), a rare earth element, or any combination thereof; D is oxygen (O), fluorine (F), sulfur (S), phosphorus (P), or any combination thereof; E is cobalt (Co), manganese (Mn), or any combination thereof; F is fluorine (F), sulfur (S), phosphorus (P), or any combination thereof; G is aluminum (Al), chromium (Cr), manganese (Mn), iron (Fe), magnesium (Mg), lanthanum (La), cerium (Ce), strontium (Sr), vanadium (V), or any combination thereof; Q is titanium (Ti), molybdenum (Mo), manganese (Mn), or any combination thereof; I is chromium (Cr), vanadium (V), iron (Fe), scandium (Sc), yttrium (Y), or any combination thereof; and J is vanadium (V), chromium (Cr), manganese (Mn), cobalt (Co), nickel (Ni), copper (Cu), or any combination thereof. For example, the positive active material may include LiCoO₂, LiMnₓO₂ₓ(x=1 or 2), LiN₁₋ₓMnₓO₂ₓ (0<x<1), LiNi_{1-x-y}CoₓMn_{y}O₂ (0≦x≦0.5 and 0≦y≦0.5), FePO₄, and/or the like.

According to one or more embodiments, the first positive active material and the second positive active material may each independently include a lithium metal composite oxide having a layered structure as a core.

For example, the lithium metal composite oxide may be lithium nickel composite oxide represented by Formula 1 below:

Liₐ(NiₓCo_{y}Mn_{z})O₂. Formula 1

In Formula 1, 0.8<a≦1.2, 0.6≦x≦1, 0≦y≦0.4, 0≦z≦0.4, and x+y+z≦1.2; Co and Mn may each independently be substituted by at least one element selected from Ca, Mg, Al, Ti, Sr, Fe, Ni, Cu, Zn, Y, Zr, Nb, and B.

A ternary lithium nickel cobalt manganese oxide represented by Formula 1 may facilitate excellent battery performance via a combination of high capacity of lithium nickel oxide, thermal stability and economic efficiency of lithium manganese oxide, and electrochemical stability of lithium cobalt oxide.

According to one or more embodiments, the core of the first positive active material and the core of the second positive active material may be the same. In other words, the first positive active material and the second positive active material may have the same composition.

The current collector may be any one of various suitable current collectors that can exhibit high conductivity without causing any chemical change in the battery. For example, the current collector may include at least one selected from aluminum, copper, nickel, titanium, and stainless steel, but is not limited thereto. The main material of the current collector (such as aluminum, copper, nickel and/or stainless steel) may be surface-treated by electroplating or ion-depositing a coating element (such as nickel, copper, aluminum, titanium, gold, silver, platinum, and/or palladium) on the surface of the main material. Alternatively, any base material prepared by coating nanoparticles of the above-described coating elements on the surface of the main material by, for example, dip coating and/or pressing may be used. In some embodiments, the current collector may be prepared by coating a conductive material on a nonconductive base material.

The current collector may have a surface on which fine irregularities are formed to enhance adhesive strength to an active material layer to be coated on the base material of the current collector.

The current collector may be used in one or more of various suitable forms including films, sheets, foils, nets, porous structures, foams, and non-woven fabrics.

In some embodiments, the current collector may have a thickness of about 3 μm to about 500 μm.

Hereinafter, a method of manufacturing the positive electrode according to one or more embodiments of the present invention will be described.

The method of manufacturing a positive electrode includes: forming a first portion of a positive active material layer by coating a first positive active material composition on at least one surface of a current collector; and forming a second portion of the positive active material layer by coating a second positive active material composition including a metal component on the first portion.

For example, the first positive active material composition may include a first positive active material, and the second positive active material composition may include a second positive active material having a coating layer including the metal component.

Compounds used to form the first positive active material are as described above, a method of preparing the second positive active material having the coating layer including the metal component will be described below.

In some embodiments, the second positive active material having the coating layer including the metal component may be formed by preparing a core of the second positive active material, and coating the core with a coating solution including the metal component. That is, the coating layer including the metal component may be formed by coating the metal component-containing coating solution on the core.

The core of the second positive active material and the metal component contained in the coating solution may be as described above. For example, the coating solution may include at least one of a metal, a metal oxide, and a lithium metal oxide. In some embodiments, the coating solution may include the metal component.

The metal component-containing coating solution may be any coating solution including a metal component, for example and without limitation, a metal component-containing compound. In some embodiments, the metal component-containing compound may be a salt including a metal, such as metal-containing acetate, metal-containing acetylacetonate, metal-containing chloride, metal-containing fluoride, and/or metal-containing hydrate.

The metal component-containing coating solution may be in the form of a solution in which the metal component-containing compound is dissolved in a solvent, or a sol in which the metal component is dispersed in a liquid. The solvent or liquid is not particularly limited, and any suitable solvent or liquid capable of dissolving or dispersing the metal component may be used. For example, water, ethanol, and/or methanol may be used as the solvent and/or liquid.

According to one or more embodiments, the coating layer may be formed by wet coating. Examples of the wet coating may include Pechini coating, dip coating, spin coating, spray coating, paint coating, bar coating, and flow coating, without being limited thereto. Any suitable coating method commonly used and/or known in the art may also be used. In some embodiments, the coating layer may be formed by Pechini coating.

The surface of the core may be coated with the coating solution by mixing the coating solution with the core. The mixing of the coating solution with the core may be performed for about 1 hour to about 3 hours. Then, the coated core may be dried at a temperature of about 50° C. to about 150° C. for about 1 hour to about 10 hours. The remaining solvent may be removed by drying.

According to one or more embodiments, the method may further include heat-treating the core on which the coating layer has been formed. By heat-treating the core on which the coating layer has been formed under atmospheric conditions, a second positive active material in which the coating layer and the core are integrated may be prepared. For example, the heat-treatment may be performed at a temperature of about 400° C. to about 1000° C. for about 1 hour to about 12 hours.

During the coating, the metal in the metal component is in an ionic form and is oxidized by the heat-treatment to form a metal oxide. Accordingly, the coating layer may include a metal oxide.

The coating solution may include about 0.05 parts by weight to about 5 parts by weight of the metal component based on 100 parts by weight of the core of the second positive active material. For example, the coating solution may include about 0.1 parts by weight to about 3 parts by weight, or about 0.5 parts by weight to about 1.5 parts by weight, of the metal component based on 100 parts by weight of the core of the second positive active material. When the amount of the metal component is within any of the ranges described above, capacity decrease and side reactions with the electrolytic solution may be inhibited or substantially reduced.

The second positive active material may further include a diffusion layer extending from the coating layer inward toward the center of the second positive active material. During the wet coating process, the coating solution may be soaked into the surface of the core. In this case, the metal in the metal component may infiltrate into the surface of the core. As a result, the infiltrated metal component may be involved in a reaction with lithium existing on the surface of or inside the core, thereby forming a lithium metal oxide. Thus, the diffusion layer may include the lithium metal oxide.

A thickness of the diffusion layer may be in a range of about 1 nm to about 500 nm. When the thickness of the diffusion layer is within the range described above, the diffusion layer may increase capacity of the battery and improve structural stability of the positive electrode.

Then, the first positive active material composition and the second positive active material composition may be prepared by respectively mixing the first positive active material and the second positive active material with a binder and, optionally, a conductive agent in a solvent.

The binder used in the positive active material composition assists in binding of the positive active material to the conductive agent, the current collector, and/or the like. An amount of the binder may be in a range of about 1 to about 50 parts by weight based on 100 parts by weight of the positive active material. For example, the amount of the binder may be in a range of about 1 to about 30 parts by weight, about 1 to about 20 parts by weight, or about 1 to about 15 parts by weight, based on 100 parts by weight of the positive electrode active material. Examples of the binder may include polyvinylidene fluoride (PVdF), polyvinylidene chloride, polybenzimidazole, polyimide, polyvinyl acetate, polyacrylonitrile, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polystyrene, polymethyl methacrylate, polyaniline, acrylonitrile butadiene styrene, phenol resin, epoxy resin, polyethylene terephthalate, polytetrafluoroethylene, polyphenyl sulfide, polyamide-imide, polyetherimide, polyethylene sulfone, polyamide, polyacetal, polyphenylene oxide, polybutylenetelephthalate, ethylene-propylene-diene monomer (EPDM), sulfonated EPDM, styrene butadiene rubber (SBR), fluoride rubber, and any combination thereof, without being limited thereto.

The positive active material composition may further include a conductive agent in order to further improve electrical conductivity by providing a sufficient conduction path to the positive active material. The conductive agent may be any suitable conductive agent that is commonly used or capable of being used in lithium batteries. Examples of the conductive agent include a carbonaceous material (such as carbon black, acetylene black, Ketjen black, and/or carbon fiber); a metal (such as copper, nickel, aluminum, and/or silver), each of which may be used in powder or fiber form; a conductive polymer (such as a polyphenylene derivative); and any mixture thereof, without being limited thereto. An amount of the conductive agent may be appropriately adjusted. For example, the conductive agent may be added such that a weight ratio of the positive active material to the conductive agent is in a range of about 99:1 to about 90:10.

Non-limiting examples of the solvent include N-methylpyrrolidone (NMP), acetone, and water. An amount of the solvent may be in a range of about 1 to about 40 parts by weight based on 100 parts by weight of the positive active material. When the amount of the solvent is within this range, a process for forming the positive active material layer may be efficiently performed.

Then, the first portion of the positive active material layer is formed by coating the first positive active material composition on the current collector. The first portion may be formed by directly coating the first positive active material composition on the current collector or by casting the first positive active material composition on a separate support to form a positive active material film, separating the positive active material film, and laminating the positive active material film on the current collector.

In this regard, thicknesses of the first portion and the second portion may be adjusted such that a thickness of the second portion is about 5% to about 70% of the total thickness of the desired positive active material layer, the second portion extending inward from the surface of the positive active material layer. For example, the second portion may be coated to have a thickness of about 10% to about 60%, or about 30% to about 60%, of the total thickness of the desired positive active material layer, the second portion extending inward from the surface of the positive active material layer. When the thickness of the second portion is within any of the ranges described above, the positive electrode may have high structural stability and excellent lifespan characteristics.

The method of embodiments of the present invention may further include drying the first portion after forming the first portion. The drying of the first portion may be performed at a temperature of about 50° C. to about 150° C. for about 1 hour to about 20 hours. The solvent may be removed by the drying, and infiltration of the second positive active material composition into the first portion may be inhibited (or substantially reduced).

Then, the second portion of the positive active material layer may be formed by coating the second positive active material composition including the metal component on the first portion. The coating method may be as described above.

After forming the second portion, the resultant structure is dried, pressed, and heat-treated in a vacuum at a temperature of about 50° C. to about 250° C. to prepare the positive electrode. The positive electrode is not limited to the shape described above and may also have various shapes.

A lithium battery according to one or more embodiments of the present invention includes the positive electrode described above. Particularly, the lithium battery includes: the positive electrode; a negative electrode opposite to the positive electrode; a separator between the positive electrode and the negative electrode; and an electrolyte. The lithium battery may be prepared as follows.

First, the positive electrode is prepared according to the method of manufacturing a positive electrode described above.

Then, the negative electrode may be prepared as follows. The negative electrode may be prepared in the same manner as the preparation of the positive electrode, except that a negative active material is used instead of the positive active material. A binder, a conductive agent, and a solvent used in a negative active material composition may be the same as those used in the positive active material composition.

For example, a negative electrode plate may be prepared by mixing the negative active material, the binder, the conductive agent, and the solvent to prepare a negative active material composition, and directly coating the negative active material composition on a Cu current collector. Alternatively, the negative electrode plate may be prepared by casting the negative active material composition on a separate support, and laminating a negative active material film separated from the support on a Cu current collector.

The negative active material may be any suitable material commonly used and/or known in the art as a negative active material for lithium batteries. For example, the negative active material may include at least one selected from a lithium metal, a metal alloyable with lithium, a transition metal oxide, a non-transition metal oxide, and a carbonaceous material.

In some embodiments, the metal alloyable with lithium may be silicon (Si), tin (Sn), aluminum (Al), gallium (Ge), lead (Pb), bismuth (Bi), antimony (Sb), a Si—Y alloy (where Y is an alkali metal, an alkali earth metal, an element of any one of Groups XIII and XIV, a transition metal, a rare-earth element, or any combination thereof, and Y is not Si), or a Sn—Y alloy (where Y is an alkali metal, an alkali earth metal, an element of any one of Groups XIII and XIV, a transition metal, a rare-earth element, or any combination thereof, and Y is not Sn). Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or any combination thereof.

For example, the transition metal oxide may be lithium titanium oxide, vanadium oxide, lithium vanadium oxide, and/or the like.

For example, the non-transition metal oxide may be SnO₂, SiOₓ(0<x<2), and/or the like.

The carbonaceous material may be crystalline carbon, amorphous carbon, and/or any mixture thereof. Non-limiting examples of the crystalline carbon include natural graphite and artificial graphite that may be in amorphous, plate-like, flake, spherical or fibrous form, and the like. Non-limiting examples of the amorphous carbon include soft carbon, hard carbon, meso-phase pitch carbides, sintered coke, and the like.

Next, a separator to be positioned between the positive electrode and the negative electrode is prepared. Any suitable separator commonly used or capable to be used in lithium batteries may be used. In some embodiments, a separator that has low resistance to migration of ions of an electrolyte and excellent electrolytic solution-retaining ability may be used. Non-limiting examples of the separator may include glass fiber, polyester, Teflon®, polyethylene, polypropylene, polytetrafluoroethylene (PTFE), and any combination thereof, each of which may be a nonwoven fabric or a woven fabric. The separator may have a pore diameter of about 0.01 to about 10 μm and a thickness of about 5 to about 300 μm.

The electrolyte may include a non-aqueous electrolyte and a lithium salt. The non-aqueous electrolyte may be a non-aqueous electrolytic solution, an organic solid electrolyte, an inorganic solid electrolyte, and/or the like.

Non-limiting examples of the non-aqueous electrolytic solution include an aprotic organic solvent such as N-methyl-2-pyrrolidone, propylene carbonate (PC), ethylene carbonate (EC), butylene carbonate, dimethyl carbonate (DMC), diethyl carbonate (DEC), ethylmethyl carbonate (EMC), gamma-butyro lactone (GBL), 1,2-dimethoxy ethane (DME), tetrahydrofuran (THF), 2-methyl tetrahydrofuran, dimethylsulfoxide (DMSO), 1,3-dioxolane (DOL), formamide, dimethylformamide, acetonitrile, nitromethane, methyl formate, methyl acetate, phosphoric acid trimester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Non-limiting examples of the organic solid electrolyte may include polyethylene derivatives, polyethylene oxide derivatives, polypropylene oxide derivatives, phosphoric acid ester polymers, polylysine, polyester sulfide, polyvinyl alcohol, polyvinylidene fluoride, and polymers containing ionic dissociation groups.

Non-limiting examples of the inorganic solid electrolyte may include a nitride, halide, and/or sulfate of Li such as Li₃N, LiI, Li₅NI₂, LiSiO₄, LiSiO₄—LiI—LiOH, Li₂SiS₃, Li₄SiO₄, Li₄SiO₄—LiI—LiOH, and/or Li₃PO₄—Li₂S—SiS₂.

The lithium salt may be any suitable lithium salt that is commonly used or capable of being used in lithium batteries and that is soluble in the non-aqueous organic solvent. For example, the lithium salt includes at least one selected from LiCl, LiBr, LiI, LiClO₄, LiBF₄, LiB₁₀Cl₁₀, LiPF₆, LiCF₃SO₃, LiCF₃Co₂, LiAsF₆, LiSbF₆, LiAlCl₄, CH₃SO₃Li, CF₃SO₃Li, (CF₃SO₂)₂NLi, lithium chloroborate, lower aliphatic carboxylic acid lithium, lithium tetraphenyl borate, and imide.

In addition, the electrolytic solution may include vinylene carbonate (VC), catechol carbonate (CC), and/or the like in order to form and maintain a solid electrolyte interface (SEI) layer on the surface of the negative electrode. The electrolyte may further include a redox-shuttle-type additive such as n-butyl ferrocene and/or halogen-substituted benzene to prevent overcharging. The electrolyte may further include a film-forming additive such as cyclohexyl benzene and/or biphenyl. The electrolyte may further include a cation receptor such as a crown ether-based compound and an anion receptor such as a boron-based compound to improve conductivity. The electrolyte may further include a phosphate-based compound such as trimethyl phosphate (TMP), tris(2,2,2-trifluoroethyl) phosphate (TFP), and/or hexamethoxycyclotriphosphazene (HMTP) as a flame retardant.

If desired, the electrolyte may further include additives such as tris(trimethylsilyl) phosphate (TMSPa), lithium difluorooxalatoborate (LiFOB), propanesultone (PS), succinonitrile (SN), LiBF₄, a silane compound having a functional group capable of forming a siloxane bond (such as an acryl, amino, epoxy, methoxy, ethoxy, and/or vinyl group), and a silazane compound (such as hexamethyl silazane) to further improve stability of the lithium battery by assisting in the formation of a stable SEI layer or film on the surface of the electrodes. For example, the electrolyte may further include additives such as PS, SN, and/or LiBF₄.

The electrolytic solution may be prepared by adding a lithium salt (such as LiPF₆, LiClO₄, LiBF₄, and/or LiN(SO₂CF₃)₂) to a mixed solvent of a cyclic carbonate (such as EC and/or PC) having a high dielectric constant and a linear carbonate (such as DEC, DMC, and/or EMC) having a low viscosity.

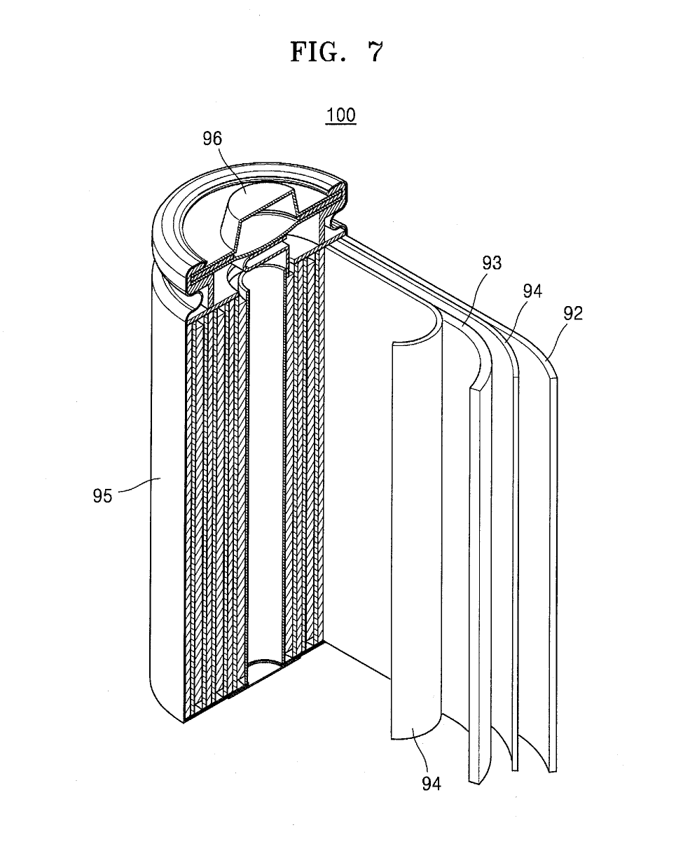

FIG. 7 is a schematic diagram of a structure of a lithium battery 100 according to one or more embodiments of the present invention.

Referring to FIG. 7, the lithium battery 100 includes a positive electrode 93, a negative electrode 92, and a separator 94 between the positive electrode 93 and the negative electrode 92. In addition, the lithium battery 100 may further include the separator 94 on the outer surface of the positive electrode 93 or the negative electrode 92 to prevent short circuit therein. The positive electrode 93, the negative electrode 92, and the separator 94 are wound or folded, and then accommodated in a battery case 95. Then, an electrolyte is injected into the battery case 95 and the battery case 95 is sealed by a sealing member 96, thereby completing the manufacture of the lithium battery 100. The battery case 95 may have a cylindrical shape, a rectangular shape, or a thin-film shape, without being limited thereto. The lithium battery may be a lithium ion battery.

Lithium secondary batteries may be classified into a winding type (winding battery) or a stack type (stack battery) according to the shape of electrodes and may also be classified into a cylindrical type (cylindrical battery), a rectangular type (rectangular battery), a coin type (coin battery), or a pouch type (pouch battery) according to the type of exterior material.

The lithium secondary battery may be used not only as a power source for small-sized devices, but also as a unit battery of a battery module in middle or large-sized devices that include a plurality of batteries.

Examples of the middle or large-sized devices include power tools; electric vehicles (EVs), hybrid electric vehicles (HEVs), and plug-in hybrid electric vehicles (PHEVs); electric motorcycles such as E-bikes and E-scooters; electric golf carts; electric trucks; electric commercial vehicles; and energy storage systems, without being limited thereto. In addition, the lithium secondary batteries may be used in any application requiring high-power output, high voltage, and/or high temperature conditions for operations.

One or more embodiments of the present invention will be described in more detail with reference to the following examples. However, these examples are for illustrative purposes only and are not intended to limit the scope of the one or more embodiments of the present disclosure.

### Preparation of Positive Active Material

### Preparation Example 1

100 parts by weight of Li[Ni_{0.65}Co_{0.20}Mn_{0.15}]O₂ powder (Samsung SDI) having an average particle diameter of 6 μm was dispersed in 95 parts by weight of distilled water. Zirconium acetylacetonate (Aldrich) was dissolved in 5 parts by weight of distilled water to prepare a coating solution such that the coating solution contained 0.5 parts by weight of zirconium. The coating solution was added to the Li[Ni_{0.65}Co_{0.20}Mn_{0.15}]O₂ dispersion, and the resulting mixture was stirred using a stirrer (magnetic stirrer in a beaker) for 60 minutes to coat the surface of the Li[Ni_{0.65}Co_{0.20}Mn_{0.15}]O₂ powder. The coated Li[Ni_{0.65}Co_{0.20}Mn_{0.15}]O₂ powder was dried at 140° C. for 5 hours and calcined at 800° C. for 8 hours under atmospheric conditions to prepare a positive active material having a coating layer including a zirconium component.

### Preparation Example 2

A positive active material was prepared in the same (or substantially the same) manner as in Preparation Example 1, except that the amount of zirconium acetylacetonate used was such that the coating solution contained 1 part by weight of zirconium, instead of 0.5 parts by weight of zirconium.

### Evaluation Example 1

### Surface Analysis of Positive Active Material (SEM)

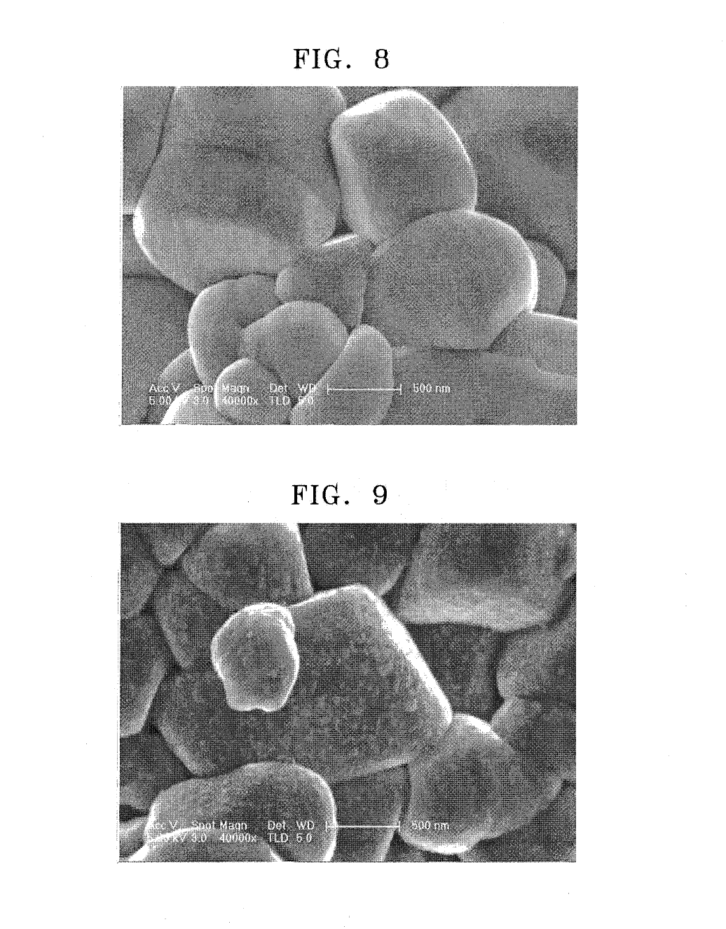

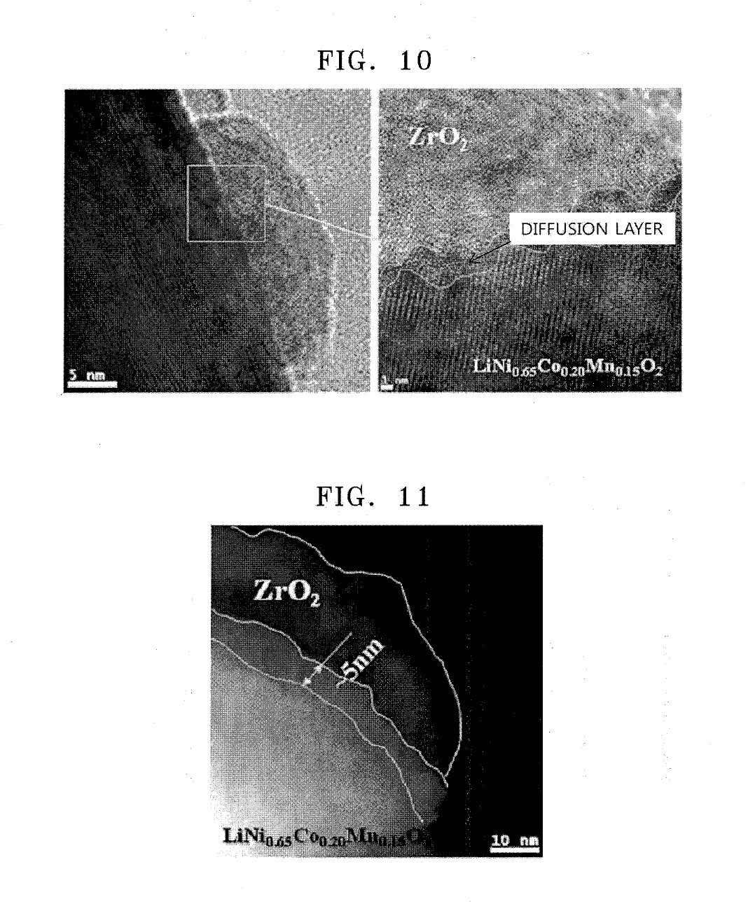

FIG. 8 is a scanning electron microscope (SEM) image of a surface of Li[Ni_{0.65}Co_{0.20}Mn_{0.15}]O₂ powder obtained with a magnification of 40,000×. FIG. 9 is an SEM image of a cross-section of the positive active material prepared according to Preparation Example 1 obtained with a magnification of 40,000×. While the positive active material without the coating layer (illustrated in FIG. 8) has a smooth surface, the positive active material prepared according to Preparation Example 1 has an island-type coating layer formed on the surface of Li[Ni_{0.65}Co_{0.20}Mn_{0.15}]O₂ powder, as illustrated in FIG. 9.

### Evaluation Example 2

### Surface Analysis of Positive Active Material (HRTEM and STEM)

FIG. 10 illustrates a high resolution transmission electron microscope (HRTEM) image of the surface of the positive active material prepared according to Preparation Example 1 obtained with a magnification of 200,000× (left) and an enlarged HRTEM image of a portion of the surface thereof obtained with a magnification of 400,000× (right).

As illustrated in FIG. 10, a coating layer including ZrO₂ is formed on the surface of Li[Ni_{0.65}Co_{0.20}Mn_{0.15}]O₂ powder, and a diffusion layer is formed between the coating layer and the surface of Li[Ni_{0.65}Co_{0.20}Mn_{0.15}]O₂ powder.

In order to measure a thickness of the diffusion layer, a scanning transmission electron microscopic (STEM) image of the surface of the positive active material prepared according to Preparation Example 1 obtained with a magnification of 100,000× was used, as illustrated in FIG. 11. The thickness of the diffusion layer was about 5 nm.

### Evaluation Example 3

### Surface Analysis of Positive Active Material (Analysis of Diffusion Layer Using STEM and XRD)

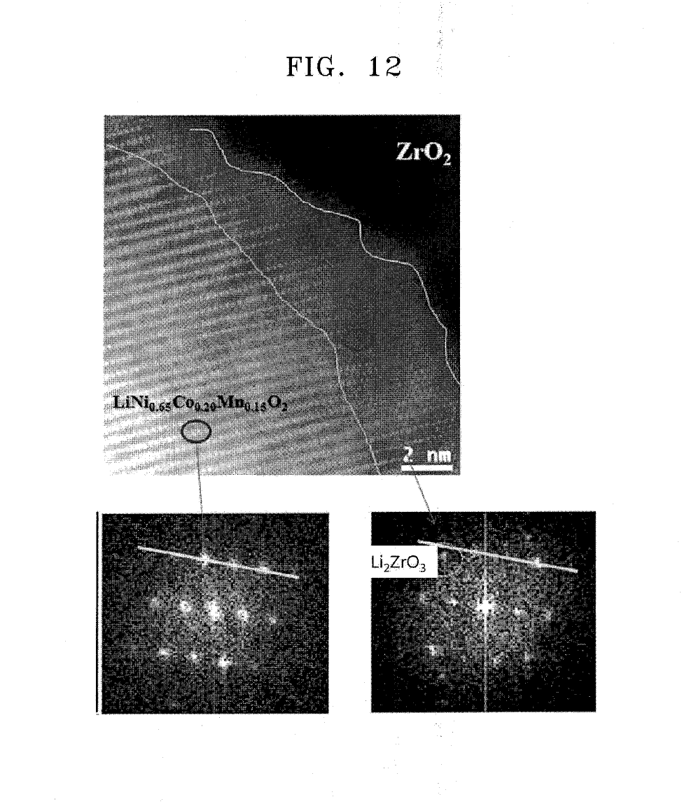

FIG. 12 illustrates an enlarged image of a portion of the STEM image of FIG. 11 (top), a fast Fourier transform (FFT) analysis image of one point of the diffusion layer (bottom left), and an FFT analysis image of one point of Li[Ni_{0.65}Co_{0.20}Mn_{0.15}]O₂ (bottom right)

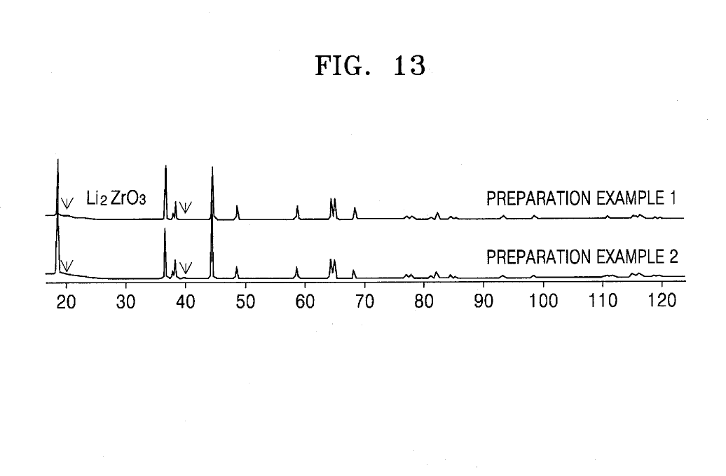

In addition, for composition analysis of the diffusion layer, the positive active materials prepared according to Preparation Examples 1 and 2 were subjected to XRD analysis. Particularly, XRD (X′Pert PRO MPD, PANalytical) analysis was performed using CuK-alpha X-rays having a wavelength of 1.541 Å. The results are shown in FIG. 13.

As illustrated in FIG. 13, the diffusion layer included Li₂ZrO₃. Thus, some zirconium used to form the coating layer infiltrated into the surface of Li[Ni_{0.65}Co_{0.20}Mn_{0.15}]O₂ powder and was involved in a reaction with lithium to form a lithium metal oxide of Li₂ZrO₃.

In addition, as illustrated in FIG. 12, Li₂ZrO₃ contained in the diffusion layer did not contribute to a layered crystal structure of Li[Ni_{0.65}Co_{0.20}Mn_{0.15}]O₂.

### Preparation of Positive Electrode

### Example 1

A first positive active material composition was prepared by mixing Li[Ni_{0.65}Co_{0.20}Mn_{0.15}]O₂ powder as a positive active material, PVDF as a binder, Denka Black as a carbonaceous conductive agent in a weight ratio of 90:5:5, and adding NMP, as a solvent, to the mixture to adjust viscosity such that a solid content (i.e., content of solids) was 60% by weight.

A second positive active material composition was prepared by mixing the positive active material prepared according to Preparation Example 1 as a positive active material, PVDF as a binder, Denka Black as a carbonaceous conductive agent in a weight ratio of 90:5:5, and adding NMP, as a solvent, to the mixture to adjust viscosity such that a solid content was 60% by weight.

The prepared first positive active material composition was coated on a 15 μm-thick Al current collector to a thickness of 5 μm by using a method commonly used in the art. Then, the current collector, on which the first positive active material composition was coated, was dried at 130° C. to prepare a first portion.

The prepared second positive active material composition was coated on the dried first portion to a thickness of 5 μm by using a method commonly used in the art. Then, the first portion on which the second positive active material composition was coated and the current collector were dried at 130° C. and pressed to prepare a positive electrode plate having a thickness of 18 μm (including the current collector) and having the first portion and a second portion formed on the a first portion. The dried positive electrode plate was heat-treated at 700° C. under atmospheric conditions for 10 hours and cut into a size of 16 mm to prepare a positive electrode to be applied to a coin cell.

### Example 2

A positive electrode was prepared in the same (or substantially the same) manner as in Example 1, except that the positive active material prepared according to Preparation Example 2 instead of the positive active material prepared according to Preparation Example 1 was used in the preparation of the second positive active material composition.

### Comparative Example 1

A positive active material composition was prepared by mixing Li[Ni_{0.65}Co_{0.20}Mn_{0.15}]O₂ powder as a positive active material, PVDF as a binder, Denka Black as a carbonaceous conductive agent in a weight ratio of 90:5:5, and adding NMP, as a solvent, to the mixture to adjust viscosity such that a solid content was 60% by weight.

The prepared positive active material composition was coated on a 15 μm-thick Al current collector to a thickness of 10 μm by using a method commonly used in the art. Then, the current collector, on which the positive active material composition was coated, was dried at 130° C. and pressed to prepare a positive electrode plate having a thickness of 20 μm (including the current collector). The dried positive electrode plate was heat-treated at 700° C. under atmospheric conditions for 10 hours and cut into a size of 16 mm to prepare a positive electrode to be applied to a coin cell.

### Comparative Example 2

A positive active material composition was prepared by mixing the positive active material prepared according to Preparation Example 1 as a positive active material, PVDF as a binder, Denka Black as a carbonaceous conductive agent in a weight ratio of 90:5:5, and adding NMP, as a solvent, to the mixture to adjust viscosity such that a solid content was 60% by weight.

The prepared positive active material composition was coated on a 15 μm-thick Al current collector to a thickness of 10 μm by using a method commonly used in the art. Then, the current collector, on which the positive active material composition was coated, was dried at 130° C. and pressed to prepare a positive electrode plate having a thickness of 20 μm (including the current collector). The dried positive electrode plate was heat-treated at 700° C. under atmospheric conditions for 10 hours and cut into a size of 16 mm to prepare a positive electrode to be applied to a coin cell.

### Evaluation Example 4

### Analysis of Cross-Section of Positive Active Material Layer

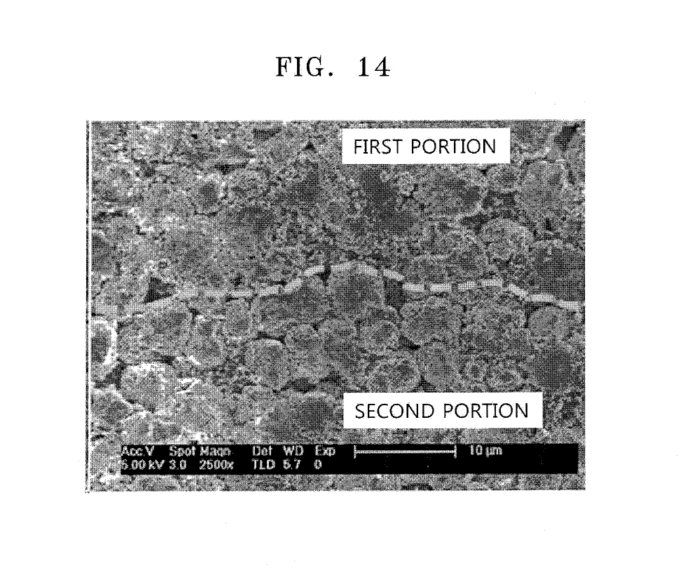

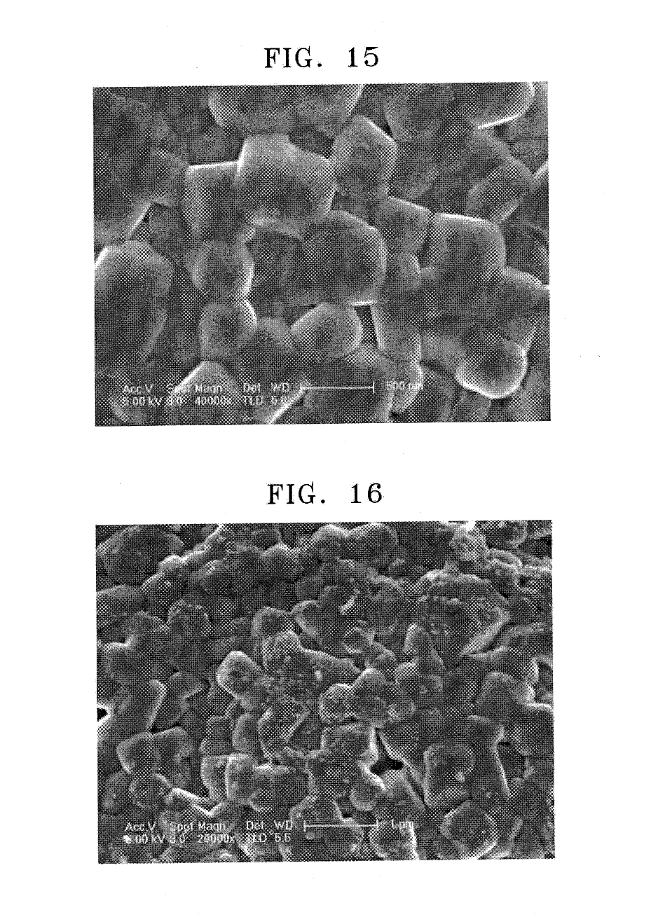

FIG. 14 is an SEM image of a cross-section of a positive active material layer prepared according to Example 1 obtained with a magnification of 2,500×. Referring to FIG. 14, an approximate border line was formed between the first portion and the second portion in the positive active material layer. SEM images of the first portion and the second portion obtained with a magnification of 40,000× were illustrated in FIGS. 15 and 16, respectively.

While the first portion includes the positive active material without a coating layer and with a smooth surface (as illustrated in FIG. 15), the second portion includes the positive active material having an island-type coating layer (as illustrated in FIG. 16).

### Evaluation Example 5

### Component Analysis of Positive Active Material Layer

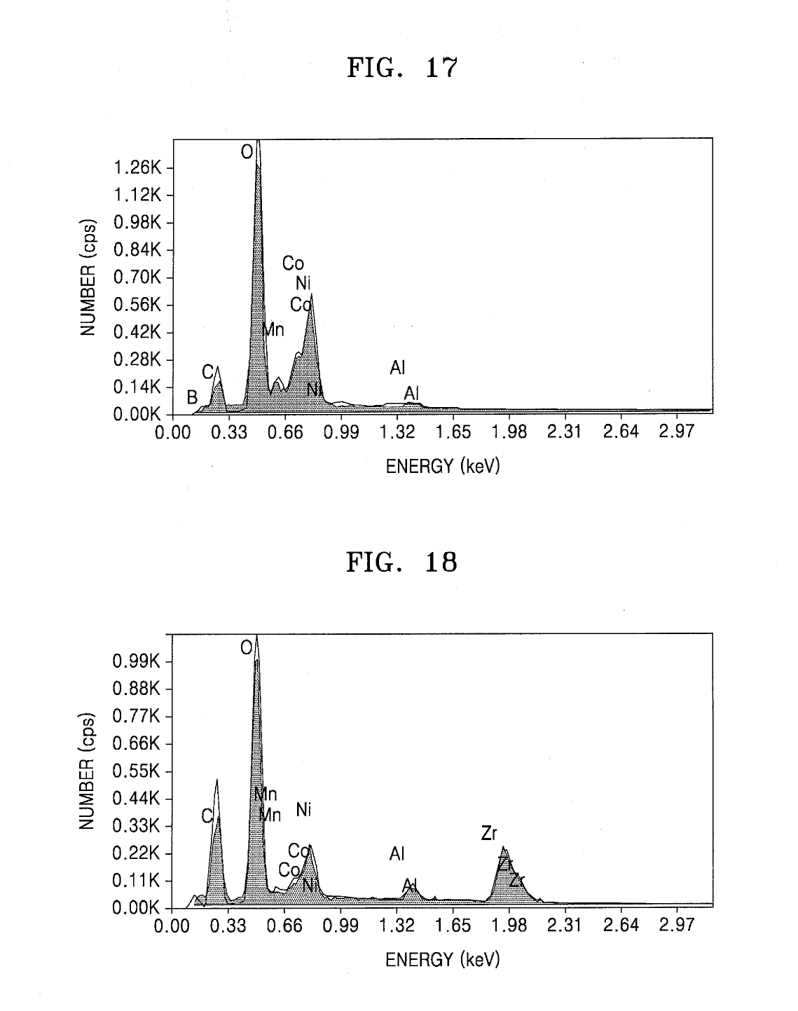

FIGS. 17 and 18 are graphs of energy dispersive X-ray analysis (EDX) results of one point of each of the first portion and the second portion of the positive active material layer prepared according to Example 1. The EDX was performed using Sirion SEM_EDX (FEI Company).

As illustrated in FIG. 17, the first portion did not include Zr, since Zr was not detected in the first portion. In contrast, as illustrated in FIG. 18, the second portion included Zr, since a large amount of Zr was detected in the second portion.

These results indicate that the metal component contained in the second positive active material composition was not mixed with the first portion during the preparation of the positive electrode. Thus, the positive electrode prepared according to the preparation method of embodiments of the present invention includes the metal component within a particular thickness inward from the surface of the positive active material layer. This is at least partially because the second positive active material composition was coated after the first positive active material composition on the current collector was coated and dried.

### Preparation of Lithium Secondary Battery-Coin Half Cell

### Example 3

A 2032 type coin cell was prepared by stacking the positive electrode prepared according to Example 1, a Li metal as a counter electrode, and a polypropylene separator having a thickness of 14 μm injecting an electrolyte into the structure, and pressing the structure. In this case, the electrolyte was prepared by dissolving 1.10 M LiPF₆ in a mixed solvent of EC, DEC, and fluoroethylene carbonate (FEC) in a volumetric ratio of 50:40:30.

### Example 4

A lithium secondary battery was prepared in the same (or substantially the same) manner as in Example 3, except that the positive electrode prepared according to Example 2 instead of the positive electrode prepared according to Example 1 was used.

### Comparative Examples 3 and 4

Lithium secondary batteries were each prepared in the same (or substantially the same) manner as in Example 3, except that the positive electrodes prepared according to Comparative Examples 1 and 2 were respectively used, instead of the positive electrode prepared according to Example 1.

### Evaluation Example 6

### Evaluation of Lifespan Characteristics

The coin half cells prepared according to Examples 3 and 4 and Comparative Examples 3 and 4 were each charged at a constant current of 0.1 C at 25° C. until a voltage reached 4.3 V and discharged at a constant current of 0.1 C until the voltage reached 2.8 V (Formation).

Then, the resulting coin half cells were each charged at a constant current of 0.2 C until the voltage reached 4.3 V and charged at a constant voltage of 4.3 V until the current reached 0.05 C, and then discharged at a constant current of 0.2 C until the voltage reached 2.8 V (Rating).

After the formation and rating, each lithium battery was charged at a constant current of 0.5 C at 25° C. until the voltage reached 4.3 V and at a constant voltage of 4.3 V until the current reached 0.05 C, and then discharged at a constant current of 0.5 C until the voltage reached 3.0 V. This cycle of charging and discharging was repeated 80 times.

Capacity retention rates (CRRs) of the coin half cells were measured, and the results are shown in Table 1 below. Here, the capacity retention rate was calculated using Equation 1 below.

Capacity retention rate [%]=[discharge capacity at 80^{th} cycle/discharge capacity at 1^{st} cycle]×100 Equation 1

TABLE 1

| | | Capacity |
|---|---|---|
| | | retention |
| | Positive active material layer | rate (%) |
| Comparative | Positive active material without a coating layer | 90.3 |
| Example 3 | | |
| Comparative | Positive active material having a coating layer | 90.8 |
| Example 4 | | |
| Example 3 | First portion: positive active material without | 91.3 |
| | a coating layer | |
| | Second portion: positive active material having | |
| | a coating layer | |
| Example 4 | First portion: positive active material without | 91.4 |
| | a coating layer | |
| | Second portion: positive active material having | |
| | a coating layer | |

As shown in Table 1, the coin half cells including the positive active materials having a coating layer including Zr (Comparative Example 4 and Examples 3 and 4) exhibited higher capacity retention rates than those including the positive active materials without a coating layer (Comparative Example 3). This is at least partially because the structural stability of the positive electrode was improved by forming the coating layer in the positive active material.

In addition, the battery prepared according to Example 4 had a higher capacity retention rate than the one prepared according to Comparative Example 4. Since the battery according to Example 4 includes the positive electrode including 1 part by weight of the zirconium component dispersed in half the thickness of the positive active material layer, the amount of the zirconium component contained in the positive active material layer may be regarded as the same as the battery according to Comparative Example 4 including the positive electrode having 0.5 part by weight of the zirconium component dispersed throughout the entire positive active material layer. Thus, although the same amount of the zirconium component was contained in the positive active material layer, in the battery cell of Example 4, where the zirconium component was included only in the second portion, side reactions with the electrolytic solution were reduced and capacity decrease was inhibited, thereby improving lifespan characteristics.

In addition, the capacity retention rate of the battery according to Example 3 was greater than that of the battery according to Comparative Example 4, as illustrated in Table 1. In other words, although the positive active material layer of the battery according to Example 3 included 0.5 parts by weight of the zirconium component dispersed in only half the thickness of the positive active material layer, while the positive active material layer of the battery according to Comparative Example 4 included 0.5 part by weight of the zirconium component dispersed throughout the entire positive active material layer, the positive active material layer of the battery of Example 3, where the zirconium component was dispersed only in the surface portion of the positive active material layer (e.g., the second portion) exhibited better lifespan characteristics than the positive active material layer of Comparative Example 4, where the zirconium component dispersed throughout the entire positive active material layer. Thus, presence of the coating layer in a portion of the positive active material layer adjacent to the current collector (e.g., the first portion) increases resistance, thereby reducing capacity of the battery.

As a result, although the lithium battery according to embodiments of the present invention includes a smaller amount of the metal component than the comparative lithium battery, the lithium battery according to embodiments of the present invention may have better lifespan characteristics than the comparative battery.

As described above, according to one or more of the above-described embodiments, the positive electrode includes a current collector and a positive active material layer on at least one surface of the current collector and including a positive active material; and the positive active material layer has a first portion adjacent to the current collector, and a second portion adjacent to an outer surface of the positive active material layer and including the metal component. Thus, the positive electrode may have high structural stability, and the lithium battery including the positive electrode may have excellent lifespan characteristics.

It should be understood that the embodiments described therein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims and equivalents thereof.

What is claimed is:

1. A positive electrode for a lithium battery, the positive electrode comprising:
a current collector; and a positive active material layer on at least one surface of the current collector,
wherein the positive active material layer comprises a positive active material, and
wherein the positive active material layer comprises a first portion adjacent to the current collector, and a second portion adjacent to an outer surface of the positive active material layer, the second portion comprising a metal component.

2. The positive electrode of claim 1, wherein the first portion comprises a first positive active material, and
the second portion comprises a second positive active material having a coating layer comprising the metal component.

3. The positive electrode of claim 1, wherein a thickness of the positive active material layer is in a range of about 1 μm to about 50 μm.

4. The positive electrode of claim 1, wherein the second portion is about 5% to about 70% of a total thickness of the positive active material layer, the second portion extending inward from the outer surface of the positive active material layer.

5. The positive electrode of claim 1, wherein the coating layer is a discontinuous island-type coating layer.

6. The positive electrode of claim 1, wherein the metal component comprises at least one element selected from the group consisting of magnesium (Mg), aluminum (Al), silicon (Si), tin (Sn), nickel (Ni), calcium (Ca), zinc (Zn), cobalt (Co), titanium (Ti), zirconium (Zr), yttrium (Y), manganese (Mn), and vanadium (V).

7. The positive electrode of claim 1, wherein the metal component is in at least one state selected from a metal state, a metal oxide state, and a lithium metal oxide state.

8. The positive electrode of claim 1, wherein the metal component comprises at least one selected from the group consisting of Zr, ZrO₂, and Li₂ZrO₃.

9. The positive electrode of claim 1, wherein an amount of the metal component is in a range of about 0.05 mol to about 0.8 mol based on 1 mol of the positive active material.

10. The positive electrode of claim 2, wherein the second positive active material further comprises a diffusion layer extending from the coating layer toward a center of the second positive active material.

11. The positive electrode of claim 10, wherein the diffusion layer comprises a lithium metal oxide.

12. The positive electrode of claim 10, wherein a thickness of the diffusion layer is in a range of about 1 nm to about 500 nm.

13. The positive electrode of claim 2, wherein the first positive active material and the second positive active material each independently comprise a lithium metal composite oxide having a layered structure.

14. The positive electrode of claim 13, wherein the lithium metal composite oxide comprises lithium nickel composite oxide represented by Formula 1:
Liₐ(NiₓCo_{y}Mn_{z})O₂, Formula 1
wherein 0.8<a≦1.2, 0.6≦x≦1, 0≦y≦0.4, 0≦z≦0.4, and x+y+z≦1.2, and Co and Mn are optionally each independently substituted by at least one element selected from the group consisting of Ca, Mg, Al, Ti, Sr, Fe, Ni, Cu, Zn, Y, Zr, Nb, and B.

15. The positive electrode of claim 13, wherein the first positive active material and the second positive active material comprise the same lithium metal composite oxide.

16. A lithium battery comprising the positive electrode according to claim 1.

17. A method of manufacturing a positive electrode for a lithium battery, the method comprising:
forming a first portion of a positive active material layer by coating a first positive active material composition on at least one surface of a current collector; and
forming a second portion of the positive active material layer by coating a second positive active material composition comprising a metal component on the first portion.

18. The method of claim 17, wherein thickness of the second portion is about 5% to about 70% of a total thickness of the positive active material layer, the second portion extending inward from an outer surface of the positive active material layer.

19. The method of claim 17, wherein the second positive active material composition comprising the metal component is prepared by preparing a core of a second positive active material and coating the core with a coating solution comprising the metal component, and
wherein the coating Solution comprises about 0.05 parts by weight to about 5 parts by weight of the metal component based on 100 parts by weight of the core of the second positive active material.

20. The method of claim 17, wherein the forming of the first portion of the positive active material layer further comprises drying the first portion of the positive active material layer after the forming of the first portion of the positive active material layer.
